(19) United States
(12) Patent Application Publication
(10) Pub. No.: US 2009/0180041 A1
(43) Pub. Date: Jul. 16, 2009

(54) MOVABLE FRONT INTERFACE DEVICE FOR A TELEVISION

(75) Inventors: Yufei WANG, Shenzhen (CN); Daiqing WANG, Shenzhen (CN); Zhiping CHEN, Shenzhen (CN); Yadong LIU, Shenzhen (CN); Guofeng FU, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: SHENZHEN TCL NEW TECHNOLOGY CO., LTD., Shenzhen (CN)

(21) Appl. No.: 12/137,050

(22) Filed: Jun. 11, 2008

(30) Foreign Application Priority Data
Jan. 14, 2008 (CN) 200810065196.7

(51) Int. Cl. H04N 5/64

(52) U.S. Cl. 348/836; 348/E05.128

(57) ABSTRACT

A television with a movable front interface device, wherein the television has a cabinetry with a front end and a back end. In one embodiment, the device has an interface plate that is attachable to the front end of the cabinetry, a fixed seat, and a movable seat that is configured to be slidably movable along a vertical direction to the fixed seat, wherein the fixed seat is connected to the cabinetry, the movable seat is connected to the fixed seat by connection arms, and the movable seat has a base and an interface plate mounted on the base, and wherein the cabinetry having a hatch on the underside to allow the movable seat to slide in.

### BACKGROUND OF THE INVENTION

1. Field of the Invention

The present invention relates to television, more specifically, to a movable front interface device for a television.

2. General Background

Recently, flat panel televisions have been made with bigger and bigger screens, and have been used as displays of digital information more than a simple TV receiving station. The latter requires the use of various terminals, wiring accesses, such as USB terminal, VGA terminal and the like, and other interface channels in association with the televisions. However, most of these terminals are arranged on the back of the television, which is inconvenient for a user to use. And simply arranging them on the front of the television will not only affect the appearance but also make the terminals, wiring accesses and other interface channels exposed to accidental damage.

What is needed, therefore, is a television with a new type of front interface device.

### SUMMARY

A television with a movable front interface device, wherein the television has a cabinetry having a front end and a back end, has an interface plate that is attachable to the front end of the cabinetry, a fixed seat, and a movable seat that is configured to be slidably movable along a vertical direction to the fixed seat, wherein the fixed seat is connected to the cabinetry, the movable seat is connected to the fixed seat by connection arms, and the movable seat has a base and an interface plate mounted on the base, and wherein the cabinetry having a hatch on the underside to allow the movable seat to slide in.

Other advantages and novel features will be drawn from the following detailed description of a preferred embodiment with attached drawings, in which:

### BRIEF DESCRIPTION OF THE DRAWINGS

FIG. 1 is an exploded perspective view of movable front interface device according to one embodiment of the present invention;

FIG. 2 is a schematic view of an assembled movable front interface device of FIG. 1;

FIG. 3 is a schematic diagram of the interface plate of FIG. 1;

FIG. 4 is a schematic diagram of the bottom lid of FIG. 1;

FIG. 5 is a schematic diagram of the movable seat of FIG. 1 when it sliding down;

FIG. 6 is a back view of the movable seat of FIG. 1;

FIG. 7 is an exploded perspective view of the connection arm of FIG. 1;

FIG. 8 is a perspective view of the movable front interface device of FIG. 1 installed in the TV cabinetry when it is not pulled down; and

FIG. 9 is a perspective view of the movable front interface device of FIG. 1 installed in the TV cabinetry when it is pulled down.

### DETAILED DESCRIPTION OF PREFERRED EMBODIMENT

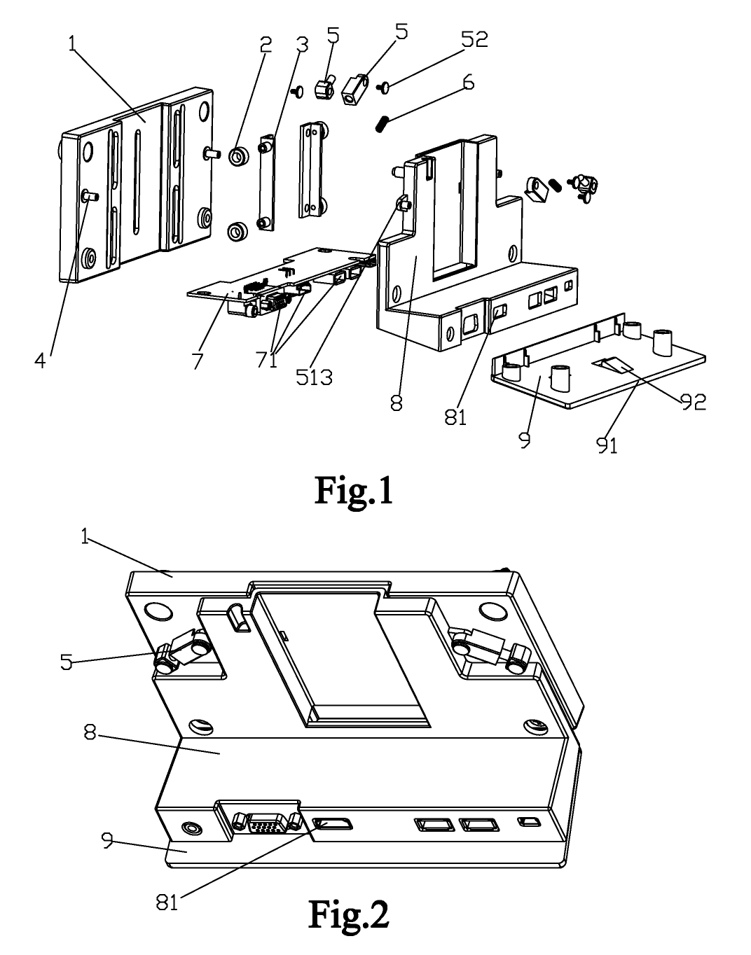

As illustrated in FIG. 1 and FIG. 2, The present invention provides a movable front interface device of television, which in one embodiment has an interface plate 7. The interface 71 of the interface plate 7 is arranged in the front of a cabinetry of the television. The movable device includes a fixed seat 1 and a movable seat 8 which is configured to slide along a vertical direction relative to the fixed seat 1. The fixed seat 1 is connected to the cabinetry. The movable seat 8 is connected to the fixed seat 1 by connection arms 5. Rollers 2 are arranged between the fixed seat 1 and the movable seat 8 to allow the movable seat 8 to slidably move up and down along the fixed seat 1. The cabinetry has a hatch on the underside to allow the movable seat 8 to slide in.

The movable seat 8 has a perforation 81 on the base. The interface 71 of the interface plate 7 stretches outside the perforation 81. The fixed seat 1 is fastened on the cabinetry, the movable seat 8 is connected with the fixed seat 1, and a roller 2 is arranged between them and allows them to slidably move to each other relatively. There is a hatch on the underside of the cabinetry of the flat TV, the width of the hatch is sized to allow the movable seat 8 to move up and down smoothly. If one pulls the movable seat 8 gently, it can make the movable seat 8 shift down and expose the interface 71 to a user for using. If one pushes the movable seat 8 upward, it will hide itself in the cabinetry when not use, so it can prevent the interfaces of television from exposure to dust, water spots, etc. This is advantageous because the interface 71 cannot be seen, at the same time, it is also very convenient for users to use.

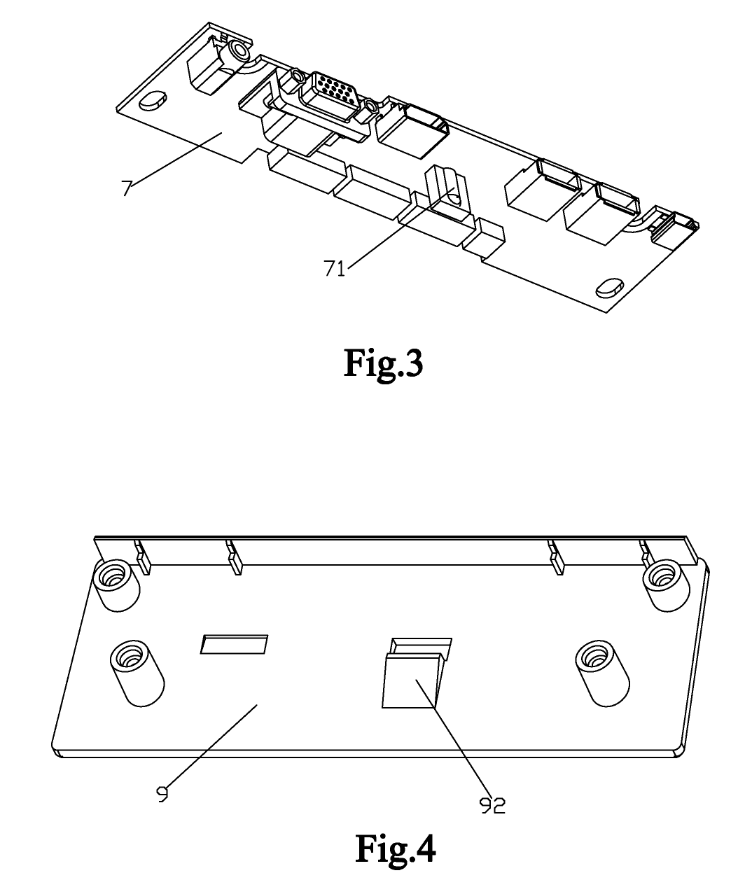

As illustrated in FIG. 1 to FIG. 4, the movable front interface device of the present invention further includes a bottom lid 9. The bottom lid 9 is mounted on the base of the movable seat 8. The bottom lid 9 also includes an outer side 91. The bottom lid 9 is made of transparent plastic and mounted under the movable seat 8 through a bolt, the outer side 91 of the bottom lid 9 is toward as formed to the direction of the screen of the television. This way, it can function as a transparent window or lens, and the emission signals of a remote controller 92 transmits through the outer side 91 of the bottom lid 9 to infrared receiving head 71 under the interface plate 7.

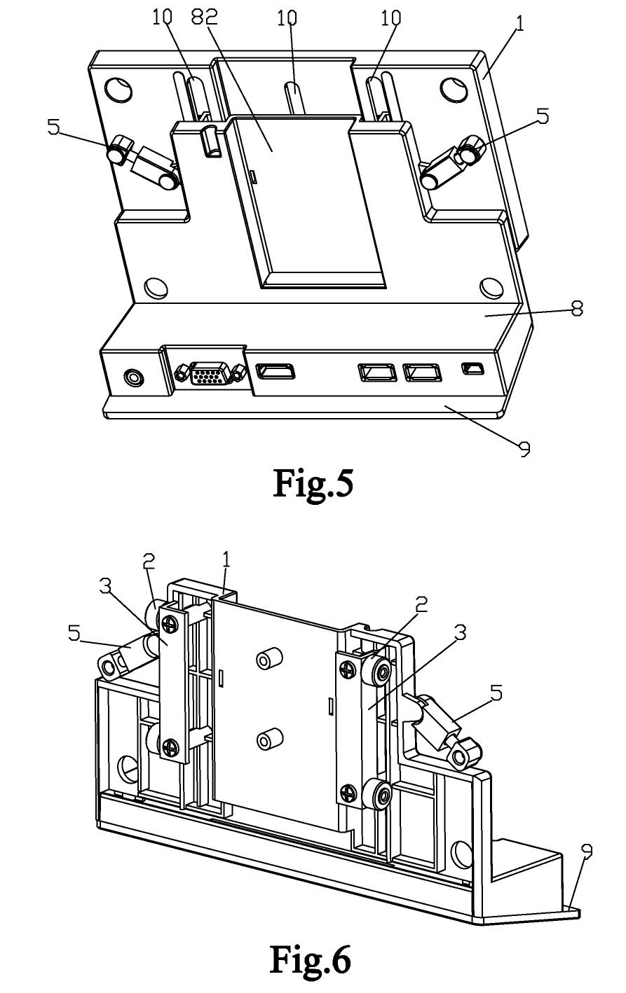

As illustrated in FIG. 5, a guide concave groove 10 is mounted on the fixed seat 1, a slidable convex groove 82 corresponding to the guide concave groove 10 is mounted on the movable seat 8. The fixed seat 1 of the present invention is a cube with screw on it, and is fastened on the back shell of television through bolt, the guide concave groove 10 is in the middle, the movable seat 8 can slide up and down along the groove smoothly. A slidable convex groove 82 is mounted on the movable seat 8. The present invention can be practiced with configurations either guide concave groove on the fixed seat 1 matched with slidable convex groove on the movable seat 8 or guide convex groove on the fixed seat 1 matched with slidable concave groove on the movable seat 8. The present configuration of guide concave groove 10 and slidable convex groove 82 allows the movable seat 8 and the fixed seat 1 sliding relatively more smoothly, and creates no attrition.

As illustrated in FIG. 1 and FIG. 6, the fixed seat 1 of the present invention further has a mounted press strip 3. The press strip 3 is formed as an L-type cube. Rollers 2 are mounted on one flange of the press strip 3. The press strip 3 of the present invention is fastened on the movable seat 8 through bolt. The rollers 2 are cylinders capable of rolling on the fixed seat 1. In one embodiment, there are four rollers 2 installed on the press strip 3 through bolts, forming a whole with the movable seat 8 and the press strip 3.

As illustrated in FIG. 2, the movable seat 8 of the present invention is formed as an L-type cube having two arm portions perpendicular to each other, wherein the moveable seat 8 is engaged with the fixed seat 1 through one of the arm portions, and is engaged with the bottom lid 9 with another of the arm portions.

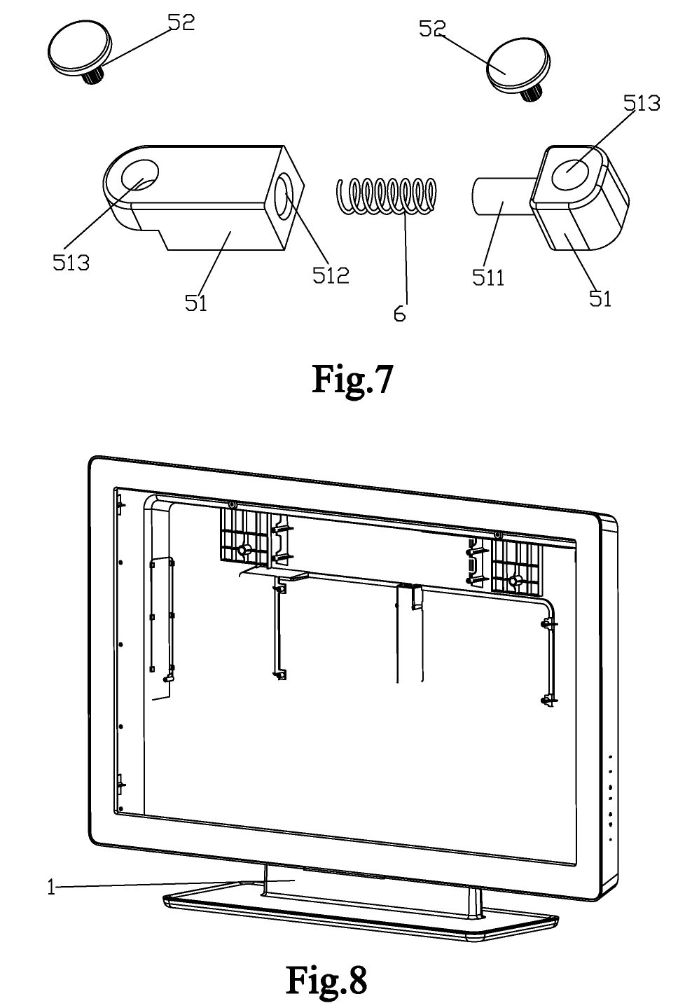

As illustrated in FIG. 1 and FIG. 2 and FIG. 5 to FIG. 7, there are two connection arms 5 mounted on the fixed seat 1 and the movable seat 8, respectively. Each of the connection arms 5 further includes a connection arm body 51 and fixed bolts 52. The body 51 is fastened respectively on the fixed seat 1 and the movable seat 8 by the fixed bolts 52. Each of the connection arms 51 includes a front arm 511. A lateral recess hole 512 is formed on the front arm 511 which is fastened on the movable seat 8. Another front arm 511 is fastened on the fixed seat 1, extending into the lateral recess hole 512. A spring 6 received in the hole 512, the front end of the front arm 511 holds one end of the spring 6, thus compresses the spring 6 and creates elasticity. The connection arm body 51 has through-holes 513 on them, the fixed seat 1 and the movable seat 8 both have mounted fixed posts 4, respectively, as illustrated in FIG. 1. The connection arms 5 are fastened on the fixed seat 1 and the movable seat 8 through the fixed posts 4 and the through-holes 513, accordingly.

As illustrated in FIG. 1 to FIG. 3, the number of the interfaces 71 on the interface plate 7 is six, one earphone interface, one HDMI interface, one VGA interface and three USB interfaces, the interface holes 81 are arranged correspondingly with each interfaces 71 in the front of the foundation of the movable seat 8, these six interfaces extended from the interface holes 81 of the movable seat 8. The total number of interfaces can be changed to meet the need of users, for instance, arrange from four, six, eight or other numbers of interfaces.

As illustrated in FIG. 2 and FIG. 8, when the movable seat 8 is not pulled down, its top levels with the fixed seat 1, at this time the direction of the two connection arms 5 are inward inclined upward, under the elasticity of the spring 6, the two connection arms cannot slid relatively, specifically, the spring 6 locating left and right pushes the movable seat 8 along the direction of the connection arms inward inclined upward. If proper pushing angle and the elasticity of the spring 6 are chosen, the movable seat 8 will not slide. As illustrated in FIG. 8, the movable front interface device of television is hided in the bottom of the television.

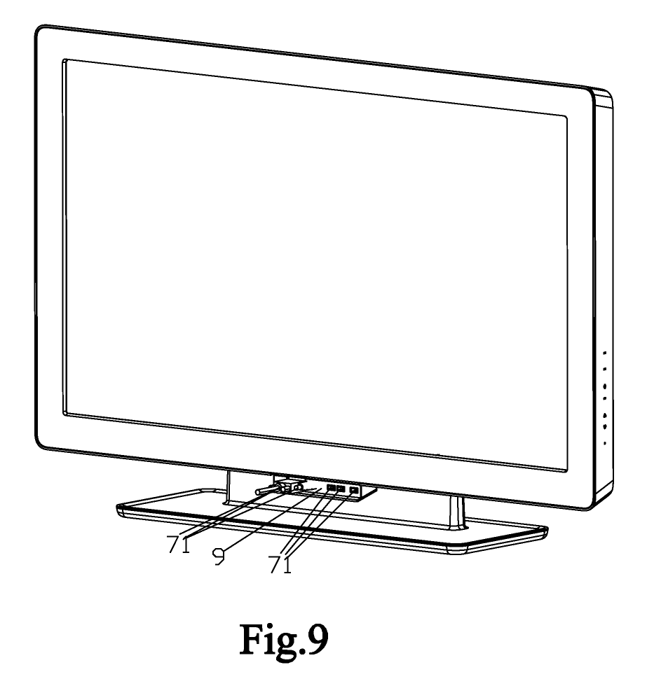

As illustrated in FIG. 5, when the bottom lid 9 is pulled down, the movable seat 8 slides down along the guide concave groove 10 of the fixed seat 1. The two connection arms 5 slide relatively and get close with each other. The spring 6 is then compressed, so some strength will be needed to overcome the elasticity and allow the bottom lid 9 to move down. When the bottom lid 9 is pulled above half, the direction of the two connection arms 5 is inward inclined downward, under the elasticity at this time, the two connection arms 5 are separated relatively, the bottom lid 9 can move up and down under the elasticity until it reaches the base. FIG. 5 is a schematic diagram after pulling down the bottom lid 9. FIG. 9 is a perspective view of the present invention installing the pull-down bottom lid.

The potential limited pull-down distance of the movable seat 8 can be confined by the relative motion distance of the slidable convex groove 82 and the guide concave groove 10, or by the movable region of the roller 2. The limited pull-down distance of the movable seat 8 gives no need to contact with the base plate, thus the movable seat 8 can be pulled down in half and then insert various terminal interface wirings. Unfix the wirings when a user is done and the bottom lid 9 is pushed upward, the two connection arms 5 slide relatively and compress the spring 6, so some strength will be needed to overcome the elasticity. When the direction of the two connection arms 5 is inward inclined upward, the elasticity will make the two connection arms 5 separated relatively, and push the movable seat 8 moves upward until it gets to the top, back to its primary position.

Thus, in one aspect of the present invention, a television with a movable front interface device is provided to solve discommodious and unpractical problems when use the interface of televisions in existing technique.

In one embodiment, a movable front interface device has, in connection with a cabinetry for positioning a television, an interface plate, wherein the interface of the interface plate is arranged in the front of the cabinetry, the movable device includes a fixed seat and a movable seat which can slide along a vertical direction to the fixed seat, the fixed seat is connected to the cabinetry, the movable seat is connected to the fixed seat by the connection arms, the movable seat has an interface plate mounted on its base, and the cabinetry has a hatch on the underside to allow the movable seat to slide in.

More specifically, the movable seat further includes a bottom lid, the bottom lid is mounted on the base of the movable seat, the interface plate is mounted on the upside of the bottom lid.

More specifically, there are two connection arms mounted on the fixed seat and the movable seat, respectively.

More specifically, the connection arms further include the connection arm body and the fixed bolts, the body fastened respectively on the fixed seat and movable seat by the fixed bolts.

More specifically, wherein each of the connection arm includes a front arm, a lateral recess hole is arranged on the front arm which is fastened on the movable seat, a spring is mounted between the another front arm which is fastened on the fixed seat and the lateral recess hole, the front arm extended into the lateral recess hole.

More specifically, wherein the connection arm body having through-holes on them, the fixed seat and movable seat both have been mounted fixed posts, the connection arms are fastened on the fixed seat and the movable seat through the fixed posts and the through-holes.

More specifically, wherein a guide concave groove is mounted on the fixed seat, a slidable convex groove matched with the guide concave groove is mounted on the movable seat.

More specifically, wherein the rollers are arranged between the fixed seat and the movable seat to permit the movable seat sliding up and down along the fixed seat. More specifically, wherein the fixed seat further mounted a press strip, the press strip is an L-type cube, the rollers are mounted on the one flange of the press strip.

More specifically, wherein the movable seat is an L-type cube, it is linked at its one end with the fixed seat, and combined together with the bottom lid at the other end.

It is to be understood that even though numerous characteristics and advantages have been set forth in the foregoing description of a preferred embodiment, together with details of the structure and function of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A television with a movable front interface device, wherein the television has a cabinetry with a front end and a back end, comprising:
(a) an interface plate that is attachable to the front end of the cabinetry;
(b) a fixed seat; and
(c) a movable seat that is configured to be slidably movable along a vertical direction to the fixed seat,
wherein the fixed seat is connected to the cabinetry, the movable seat is connected to the fixed seat by connection arms, and the movable seat has a base and an interface plate mounted on the base, and wherein the cabinetry having a hatch on the underside to allow the movable seat to slide in.

2. The television of claim 1, wherein the movable seat further comprises a bottom lid, the bottom lid is mounted on the base of the movable seat, the interface plate is mounted on the upside of the bottom lid.

3. The television of claim 1, wherein there are two connection arms mounted on the fixed seat and movable seat, respectively.

4. The television of claim 3, wherein each of the connection arms has a connection arm body and fixed bolts to fasten the connection arm body to a corresponding one of the fixed seat and movable seat.

5. The television of claim 4, wherein each of the connection arms has a front arm, a lateral recess hole is formed on the front arm that is fastened on the movable seat, a spring is mounted between the another front arm which is fastened on the fixed seat and the lateral recess hole, the front arm is extended into the lateral recess hole.

6. The television of claim 5, wherein the connection arm body has through-holes on it, the fixed seat and the movable seat both have mounted fixed posts, the connection arms are fastened on the fixed seat and the movable seat through the fixed posts and the through-holes, respectively.

7. The television of claim 1, wherein a guide concave groove is mounted on the fixed seat, a slidable convex groove matched with the guide concave groove is mounted on the movable seat.

8. The television of claim 7, wherein rollers are arranged between the fixed seat and the movable seat to allow the movable seat to slidably move up and down along the fixed seat.

9. The television of claim 8, wherein the fixed seat further comprises a mounted press strip, the press strip is formed as an L-type cube having two arm portions perpendicular to each other, the rollers are mounted on one arm portion of the L-type press strip.

10. The television of claim 9, wherein the movable seat is formed as an L-type cube having two arm portions perpendicular to each other, and wherein the movable seat is engaged with the fixed seat through one arm portion of the L-type movable seat, and is engaged with the bottom lid through another arm portion of the L-type movable seat, respectively.
